(19) United States
(12) Patent Application Publication
(10) Pub. No.: US 2018/0294112 A1
(43) Pub. Date: Oct. 11, 2018

(54) DOME SWITCH AND SMART CARD

(71) Applicant: SHENZHEN EXCELSECU DATA TECHNOLOGY CO., LTD., Shenzhen, Guangdong (CN)

(72) Inventor: Liuzhang Chen, Shenzhen, Guangdong (CN)

(21) Appl. No.: 15/548,806

(22) PCT Filed: May 9, 2017
(86) PCT No.: PCT/CN2017/083547

§ 371 Date: Aug. 4, 2017

(30) Foreign Application Priority Data
Apr. 11, 2017 (CN) 201720372180.5

(51) Int. Cl. H01H 13/704; G06K 19/077; H01H 13/705

(52) U.S. Cl. CPC H01H 13/704; G06K 19/077; H01H 2213/016; H01H 2209/014; H01H 2229/028; H01H 13/705

(57) ABSTRACT

A dome switch includes a first release membrane, a dome, a shim, and a second release membrane, the dome is mounted at an underside of the first release membrane, the second release membrane seals one end of a through opening of the shim, when the dome switch is mounted on a circuit board, a sealed space can be formed, ensuring that in the manufacture process of a smart card, the glue will not flow into the dome and hence the second release membrane will not be connected and adhered to the glue within the card, which may otherwise result in poor hand-tactile impression of the switch. The dome switch and the smart card with the dome switch presents good hand-tactile impression; the production rate is high and the rejection rate and the production cost are low.

### TECHNICAL FIELD

The present application pertains to the technical field of the dome switch, and more particularly relates to a dome switch and a smart card.

### BACKGROUND

Dome switches of existing smart cards present relatively poor hand-tactile impression. This is primarily because a distance between the surface of the dome switch and the inner side of the card is difficult to be controlled, resulting in too much glue in the switch or insufficient sealing of the switch, and the glue will flow within the switch and adheres to the dome, such that the hand-tactile impression is poor, the reject rate is high, and bulk production is difficult.

### BRIEF DESCRIPTION

An objective of the present application is to provide a dome switch and a smart card, which aims at, among others, solving technical problems of poor hand-tactile impression and high rejection rate existing in the dome switch of the smart card of the prior art.

To achieve the above objective, the present application proposes the following solution: a dome switch, which comprises:

a first release membrane having a mounting hole;

a dome mounted at an underside of the first release membrane, wherein a dome central portion of the dome is aligned with the mounting hole, and a periphery of the dome is opposite to the underside of the first release membrane;

a shim connected with a top side of the first release membrane, wherein the shim has a through opening for accommodating the dome; and

a second release membrane connected with one side of the shim, which side being opposite to the first release membrane, wherein the second release membrane is sealingly arranged at one end of the through opening.

Further, the underside of the first release membrane is provided with a double-sided adhesive.

Further, both sides of the shim are provided with double-sided adhesive.

Further, a shape of a periphery of the shim matches with a shape of a periphery of the first release membrane.

Further, the side of the shim opposite to the first release membrane and the dome central portion of the dome are arranged at a same level;

or, the side of the shim opposite to the first release membrane is lower in height than the dome central portion of the dome.

Further, the side of the shim opposite to the first release membrane is lower than the dome central portion of the dome, and a distance between the dome central portion of the dome and the side of the shim opposite to the first release membrane ranges between 0 and 0.2 mm.

Further, the dome switch further comprises a protective membrane connected with the underside of the first release membrane, and the dome is located between the protective membrane and the first release membrane.

Further, the first release membrane is provided with a ventilation slot.

Further, the shim is a PET membrane.

A smart card is also provided by the present application, and the smart card comprises the above dome switch.

Technical effects of the present application compared to the prior art are as follows: the dome is mounted at the underside of the first release membrane, the second release membrane seals one end of the through opening of the shim, when the dome switch is mounted on a circuit board, a sealed space can be formed, ensuring that in the manufacture process of the smart card, the glue will not flow into the dome and the second release membrane will not be connected and adhered to the glue within the card, which may otherwise result in poor hand-tactile impression of the switch. The dome switch and a smart card with the dome switch present good hand-tactile impression, the production rate is high; and the rejection rate and the production cost are low.

### BRIEF DESCRIPTION OF THE DRAWINGS

In order to describe the technical solutions of the embodiments of the present application more clearly, the drawings that are concerned in the embodiments or the prior art are briefly introduced herein below. It is obvious that the drawings in the following description are only some embodiments of the present application, and those skilled in the art can obtain other drawings according to these drawings without creative work.

FIG. 1 is a front view of a dome switch provided by an embodiment of the invention;

FIG. 2 is a cut-away view along line A-A of FIG. 1;

FIG. 3 is a schematic view of assemblage of a dome and a shim applied in the dome switch of FIG. 2; and

FIG. 4 is a schematic view of a structure of the dome applied in the dome switch of FIG. 2.

### DETAILED DESCRIPTION

In order to make the purposes, technical solutions, and advantages of the present invention clearer and more understandable, the present invention will be further described in detail hereinafter with reference to the accompanying drawings and embodiments. It should be understood that the embodiments described herein are only intended to illustrate but not to limit the present application.

It should be noted that when an element is described as “fixed” or “arranged” on/at another element, it means that the element can be directly or indirectly fixed or arranged on/at another element. When an element is described as “connected” to/with another element, it means that the element can be directly or indirectly connected with/with another element.

It should be understand that terms like “first” and “second” are only used for the purpose of description, and will in no way be interpreted as indication or hint of relative importance or implicitly indicate the number of the referred technical features. Thus, the features prefixed by “first” and “second” will explicitly or implicitly represent that one or more of the referred technical features are included. In the description of the present application, “multiple”/“a plurality of” refers to the number of two or more than two, except for clear and particular restriction.

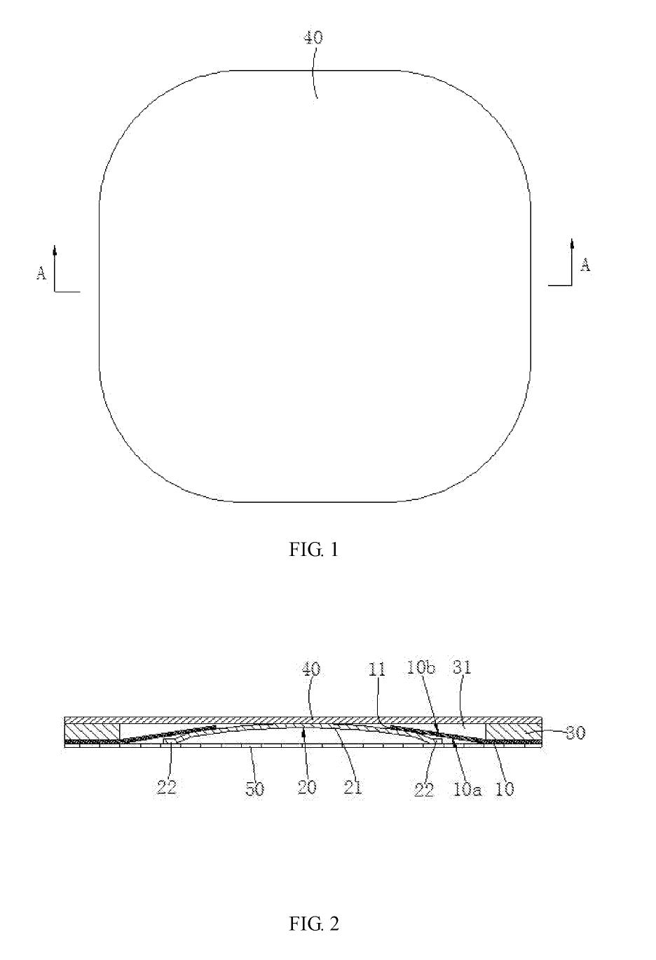

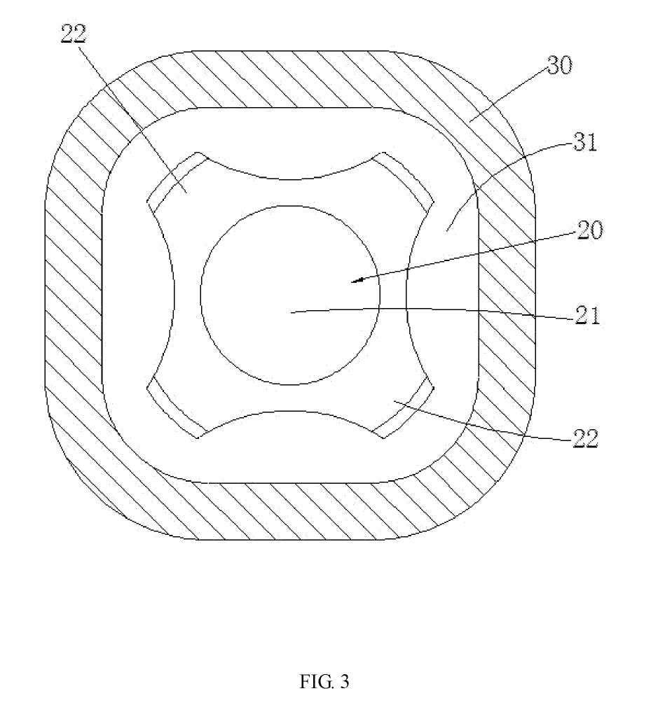

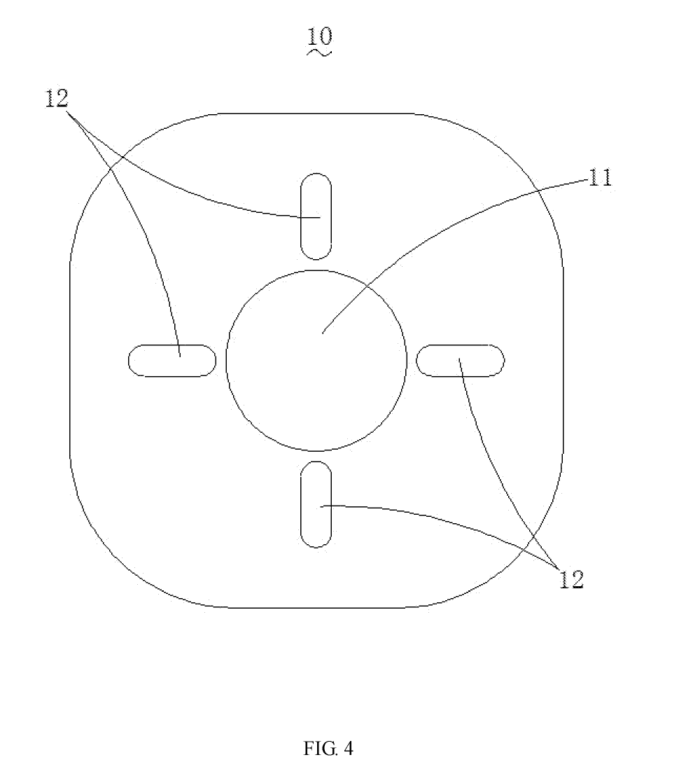

Please refer to FIG. 1 to FIG. 4, a dome switch provided by the present application is firstly described. The dome switch comprises a first release membrane 10 having a mounting hole 11; a dome 20 mounted at an underside 10a of the first release membrane 10, wherein a dome central portion 21 of the dome 20 is aligned with the mounting hole 11, and a periphery 22 of the dome 20 is opposite to the underside 10a of the first release membrane 10; a shim 30 connected with a top side 10b of the first release membrane 10, wherein the shim 30 has a through opening 31 for accommodating the dome 20; and a second release membrane 40 connected with one side of the shim 30 opposite to the first release membrane 10, where the second release membrane 40 is sealingly arranged at one end of the through opening 31.

The dome 20 is mounted at the underside 10a of the first release membrane 10, the second release membrane 40 seals one end of the through opening 31 of the shim 30, when the dome switch is mounted on a circuit board (not shown in figures), a sealed space can be formed, ensuring that in the manufacture process of a smart card, the glue will not flow into the dome 20 and the second release membrane 40 will not be connected and adhered to the glue within the card, which may otherwise result in poor hand-tactile impression of the switch. The dome switch presents good hand-tactile impression; the production rate is high and the rejection rate and the production cost are low.

The dome 20 is mounted on the circuit board, the periphery of the dome 20 is electrically connected with one solder pad of the circuit board. When the dome 20 is pressed, the dome central portion of the dome 20 contacts with another solder pad of the circuit board located beneath the dome central portion of the dome 20, so that electric connection between the two solder pads is established, and the dome 20 is switched on.

The second release membrane 40 is supported by the shim 30. For a dome 20 with a different height, by regulating a thickness of the shim 30, a distance between an inner side surface of the second release membrane 40 and a top side of the dome central portion of the dome 20 can be regulated to enable the inner side surface of the second release membrane 40 to approach the top side of the dome central portion of the dome 20. When the second release membrane 40 deforms, the dome 20 deforms along with the second release membrane 40, so that the dome 20 is switched on. Therefore, the smart cards of different thicknesses can be satisfied, the production rate is high, and the production cost is low.

Further, according to a particular embodiment of the dome switch provided by the present application, the underside 10a of the first release membrane 10 is provided with a double-sided adhesive (not shown in the figures). This concept is adapted to adhere the dome 20 to the underside 20a of the first release membrane 10 and to adhere the dome switch to the circuit board, so that the dome switch form a sealed unit, thereby preventing the glue from flowing into the dome 20.

Further, according to a particular embodiment of the dome switch provided by the present application, both sides of the shim 30 are provided with double-sided adhesive (not shown in figures). This concept is adapted to adhere the shim 30 to the top side 10b of the first release membrane 10 and to adhere the second release membrane 40 to the top side of the shim 30.

Further, according to a particular embodiment of the dome switch provided by the present application, a shape of a periphery of the shim 30 matches with a shape of a periphery of the first release membrane 10. The structure of such a scheme is compact. A shape of a periphery of the second release membrane 40 matches with the shape of the periphery of the shim 30. The shape of the periphery of the shim 30 can be circular, rectangular, or in other shapes.

Further, according to a particular embodiment of the dome switch provided by the present application, the side of the shim 30 opposite to the first release membrane 10 and the dome central portion 21 of the dome 20 are arranged at a same level; or, the side of the shim 30 opposite to the first release membrane 10 is lower than in height the dome central portion 21 of the dome 20. According to the thickness of the smart card, the thickness of the shim 30 and the height of the dome 20 are coordinately regulated at the same time, to make the inner side surface of the second release membrane 40 abut against the top side of the dome central portion of the dome 20. When the second release membrane 40 deforms, the dome 20 deforms along with the second release membrane 40, so that the dome 20 is switched on. Therefore, the smart cards of different thicknesses can be satisfied, the production rate is high, and the production cost is low. A distance between the surface of the dome switch and the surface of the card is equal to or smaller than 0.25 mm.

Further, when the side of the shim 30 opposite to the first release membrane 10 is lower than the dome central portion 21 of the dome 20, a distance between the dome central portion 21 of the dome 20 and the side of the shim 30 opposite to the first release membrane 10 ranges between 0 and 0.2 mm. This concept enables the dome central portion 21 of the dome 20 to abut against the inner side surface of the second release membrane 40, and when the second release membrane 40 deforms, the dome 20 deforms along with the second release membrane 40, so that the dome 20 is connected with the circuit board, and the hand-tactile impression of the press is good. Preferably, the distance between the dome central portion 21 of the dome 20 and the side of the shim 30 opposite to the first release membrane 10 is 0.1 mm.

Further, according to a particular embodiment of the dome switch provided by the present application, a protective membrane 50 connected with the underside 10a of the first release membrane 10 is further comprised; the dome 20 is located between the protective membrane 50 and the first release membrane 10. The protective membrane 50 is used to protect the dome 20. In fabrication of the smart card, the protective membrane 50 is peeled off, and the double-sided adhesive on the underside of the first release membrane 10 is adhered to a position for the dome switch on the circuit board.

Further, according to a particular embodiment of the dome switch provided by the present application, the first release membrane 10 is provided with a ventilation slot 12. This concept enables two sides of the first release membrane 10 to communicate, and air flow to pass through the ventilation slot 12, thereby improving the hand-tactile impression of pressing. A plurality of ventilation slots 12 are arranged on the first release membrane 10 in a circumferential direction thereof, thereby improving the hand-tactile impression of pressing.

Further, according to a particular embodiment of the dome switch provided by the present application, the shim 30 is a PET membrane with high stability. Both the first release membrane 10 and the second release membrane 40 are PET release membranes which will not be connected and adhered to the glue within the card, which may otherwise result in poor hand-tactile impression of the switch.

Please refer to FIG. 1 to FIG. 4, a smart card including the above-described dome switch is further provided. The underside of the first release membrane 10 is connected with the switch of the circuit board and forms a sealed space together with the circuit board, thereby keeping the glue outside. The dome 20 is mounted at the underside 10a of the first release membrane 10, the second release membrane 40 seals one end of the through opening 31 of the shim 30; when the dome switch is mounted on a circuit board, a sealed space can be formed, ensuring that in the manufacture process of the smart card, the glue will not flow into the dome 20 and the second release membrane 40 will not be connected and adhered to the glue within the card, which may otherwise result in poor hand-tactile impression of the switch. The smart card with dome switch presents good hand-tactile impression; the production rate is high and the rejection rate and the production cost are low. It can be understood that the number of the dome switches is not limited.

The aforementioned embodiments are only preferred embodiments of the present application, which are in no way used for limiting the present invention. Any modification, equivalent replacement and improvement which are made within the spirit and the principle of the present application should be included in the scope of the present application.

1. A dome switch, comprising:
a first release membrane having a mounting hole;
a dome mounted at an underside of the first release membrane, wherein a dome central portion of the dome is aligned with the mounting hole, and a periphery of the dome is opposite to the underside of the first release membrane;
a shim connected with a top side of the first release membrane, wherein the shim has a through opening for accommodating the dome; and
a second release membrane connected with one side of the shim, which side being opposite to the first release membrane, wherein the second release membrane is sealingly arranged at one end of the through opening.

2. The dome switch of claim 1, wherein the underside of the first release membrane is provided with a double-sided adhesive.

3. The dome switch of claim 1, wherein both sides of the shim are provided with double-sided adhesive.

4. The dome switch of claim 1, wherein a shape of a periphery of the shim matches with a shape of a periphery of the first release membrane.

5. The dome switch of claim 1, wherein the side of the shim opposite to the first release membrane and the dome central portion of the dome are arranged at a same level;
or, the side of the shim opposite to the first release membrane is lower in height than the dome central portion of the dome.

6. The dome switch of claim 1, wherein the side of the shim opposite to the first release membrane is lower than the dome central portion of the dome, and a distance between the dome central portion of the dome and the side of the shim opposite to the first release membrane ranges between 0 and 0.2 mm.

7. The dome switch of claim 1, further comprising a protective membrane connected with the underside of the first release membrane, wherein the dome is located between the protective membrane and the first release membrane.

8. The dome switch of claim 1, wherein the first release membrane is provided with a ventilation slot.

9. The dome switch of claim 1, wherein the shim is a PET membrane.

10. A smart card, comprising the dome switch according to claim 1.
